(19) United States
(12) Patent Application Publication
(10) Pub. No.: US 2007/0063675 A1
(43) Pub. Date: Mar. 22, 2007

(54) Method and system for providing battery usable life information to users of information handling systems

(76) Inventors: Erin K. Walline, Pfluggerville, TX (US); Alan C. Becklein, Round Rock, TX (US); Alison Gardner, Austin, TX (US); Lakshmipriya Kothandaraman, Pflugerville, TX (US); Bruce Miller, Plano, TX (US); Carrie L. Quintanilla, Cedar Park, TX (US)

Correspondence Address: Brian W. Peterman;O'KEEFE, EGAN & PETERMAN, LLP, Suite 200, 1101 Capital of Texas Highway South, Austin, TX, 78746, US

(21) Appl. No.: 11/229,885

(22) Filed: Sep. 19, 2005

(51) Int. Cl. H02J 7/00

(52) U.S. Cl. 320/132

(57) ABSTRACT

Systems and methods are disclosed for providing battery health information to users of portable information handling systems. Battery health information is displayed to a user along with information concerning the limited life of a rechargeable battery. The battery health information may include, for example, a good condition indicator, a critical condition indicator and one or more intermediate condition levels. In addition, battery health information, customer battery usage information and other battery health related data can also be logged for later use in troubleshooting by users or remote technicians or for other desired purposes.

### TECHNICAL FIELD OF THE INVENTION

This invention relates to battery management in a portable computing system, and more particularly to providing battery related information to a user of such a system.

### BACKGROUND

As the value and use of information continues to increase, individuals and businesses seek additional ways to process and store information. One option available to users is information handling systems (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems, such as portable notebook computers, typically utilize rechargeable batteries for power when the system is not plugged into a powered socket. One parameter that is often monitored in such portable systems is the amount of charge left in the battery before it will need to be recharged. This parameter is often deemed a measure of the battery life. A wide range of prior systems and solutions also provide battery power management techniques for extending the battery life as long as possible before recharging is required.

The usable life of a rechargeable battery, however, is a different parameter from what is often deemed “battery life.” This battery end-of-life parameter addresses the point at which a rechargeable battery can no longer hold a useful charge and does not address how much charge is left in a particular charging cycle. Based upon current technology, rechargeable batteries can only be recharged a certain number of times before they will no longer hold charge. And over time, the charging capacity of the battery is reduced. Thus, once a rechargeable battery is put into use, it is inevitable that its performance will degrade over time and will ultimately have to be replaced. Many users and purchasers of portable computers, however, do not understand this end-of-life limitation on rechargeable batteries. In fact, many users often expect the batteries that are installed in purchased portable computers, or the batteries they purchase as accessories, to have a usable life that is as long as the life for the portable computer itself. Unfortunately, based upon current battery technology, this is an unreasonable expectation.

When a user begins to experience degraded performance, the user may contact technical support. Because the user may have unreasonable expectations concerning the performance of the rechargeable battery, the user may request or demand a new battery believing the existing battery to be defective in some way. The technical support person may then have few options in order to satisfy the user other than to provide the user a new battery. This action, however, only starts the process again.

As indicated above, many hardware and software implementations exist for providing indications of battery charge status (i.e., how much longer the battery has until it needs to be re-charged). However, providing feedback on battery end-of-life is not currently done in an effective manner. Hewlett-Packard systems have provided power management information about the battery via a Battery Optimizer application. Similarly, IBM systems have provided information about power management in a Battery MaxiMiser application. The information in both applications includes things such as cycle count, device chemistry, design voltage, full charge capacity, and design capacity. With respect to end-of-life information, U.S. Pat. No. 6,545,488 (assigned to INTEL) does provide an indication that a battery has reached a critical state such that it is no longer holding a charge. In addition, the system of this patent provides an indication of the battery capacity, allows a user to select notification times, and discusses the use of multiple windows and information boxes.

Although these prior solutions have attempted to provide battery life (charge remaining) information and critical warnings when end-of-life has been reached, prior solutions have not adequately informed the user of the health of rechargeable batteries and their operational condition throughout the operational life of the rechargeable battery. In addition, prior solutions have not provided adequate tools to technical support persons to handle rechargeable battery complaints.

### SUMMARY OF THE INVENTION

The present invention provides systems and methods for providing battery health information to users of portable information handling systems. As described herein, battery health information is displayed to a user along with information concerning the limited life of a rechargeable battery. The battery health information may include, for example, a good condition indicator, a critical condition indicator and one or more intermediate condition levels. In addition, battery health information, customer battery usage information and other battery health related data can also be logged for later use in troubleshooting by users or remote technicians or for other desired purposes.

In one embodiment, the present invention is a method for informing a user of battery usable life information for an information handling system including determining a current usable life condition for at least one rechargeable battery within an information handling system, displaying normal level condition information to a user when the usable life condition is above a normal threshold level where the normal level condition information includes usable life expectation information, displaying critical level condition information to a user when the usable life condition below is a critical threshold level, and displaying caution level condition information to a user when the usable life condition is below the normal threshold level and above the critical threshold level. The condition level information can also be automatically displayed, if desired. In addition, the usable life expectation information can include information informing the user that the rechargeable battery has a limited usable life and at some point will have to be replaced. In addition, the method can include storing battery usage data related to the battery. Still further, the method can include obtaining information from the battery and determining a percentage of usable life remaining as a representation for the current usable life condition for the rechargeable battery. And the user can be allowed to select the percentages used for the threshold levels. Furthermore, the method can include determining a percentage of usable life remaining by obtaining a number of actual recharge cycles used for the battery and comparing it to an expected number of total recharge cycles for the battery, or by obtaining a current charge capacity for the battery and comparing it to a full charge capacity for the battery, or by doing both.

In another embodiment, the present invention is a battery health monitor for informing a user of battery usable life information for a rechargeable battery within an information handling system including normal level condition screen information configured to be displayed to a user when a current usable life condition for a rechargeable battery is above a normal threshold level where the normal level condition screen information includes usable life expectation information, critical level condition screen information configured to be displayed to a user when the current usable life condition below is a critical threshold level, and caution level condition screen information configured to be displayed to a user when the current usable life condition is below the normal threshold level and above the critical threshold level. A selectable menu can also be provided to allow a user to select one of a plurality of rechargeable batteries for which battery usable life information will be displayed. Still further, the usable life expectation information can include information informing the user that the rechargeable battery has a limited usable life and at some point will have to be replaced. In addition, the current usable life condition for the rechargeable battery can be based upon a percentage of usable life remaining for the rechargeable battery. Furthermore, the percentage of usable life remaining can be dependent upon a comparison of a number of actual recharge cycles used and an expected number of total recharge cycles for the battery, or upon a comparison of current charge capacity and a full charge capacity for the battery, or upon both.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a block diagram for a portable information handling system (IHS) with rechargeable batteries and a battery health monitor (BHM) displaying one of a plurality of BHM information screens to a user of the portable information handling system.

FIG. 2 is a diagram for a good condition BHM information screen that may be displayed to a user according to the present invention.

FIG. 3 is a diagram for a first level caution condition BHM information screen that may be displayed to a user according to the present invention.

FIG. 4 is a diagram for a second level caution condition BHM information screen that may be displayed to a user according to the present invention.

FIG. 5 is a diagram for a critical condition BHM information screen that may be displayed to a user according to the present invention.

### DETAILED DESCRIPTION OF THE INVENTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a server computer system, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

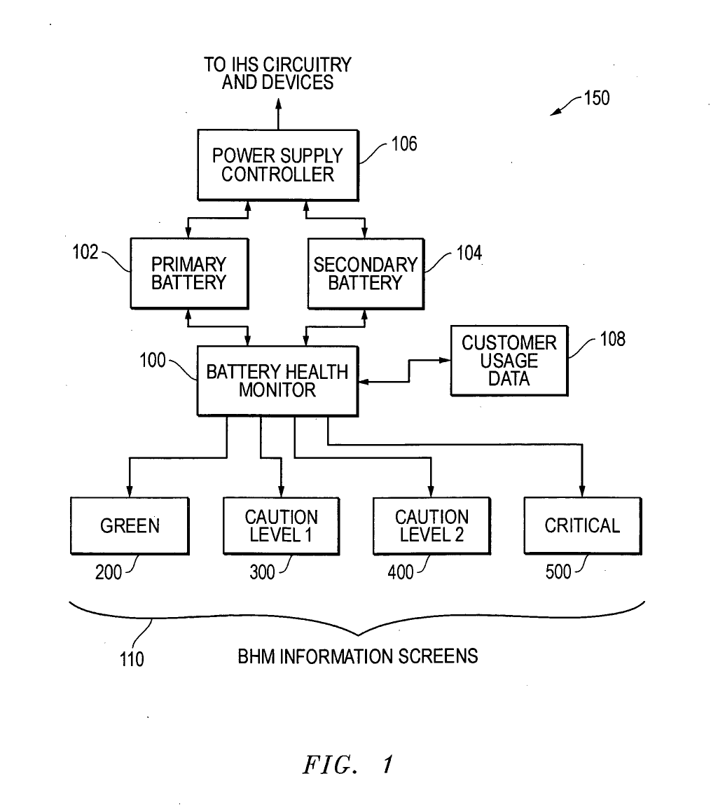

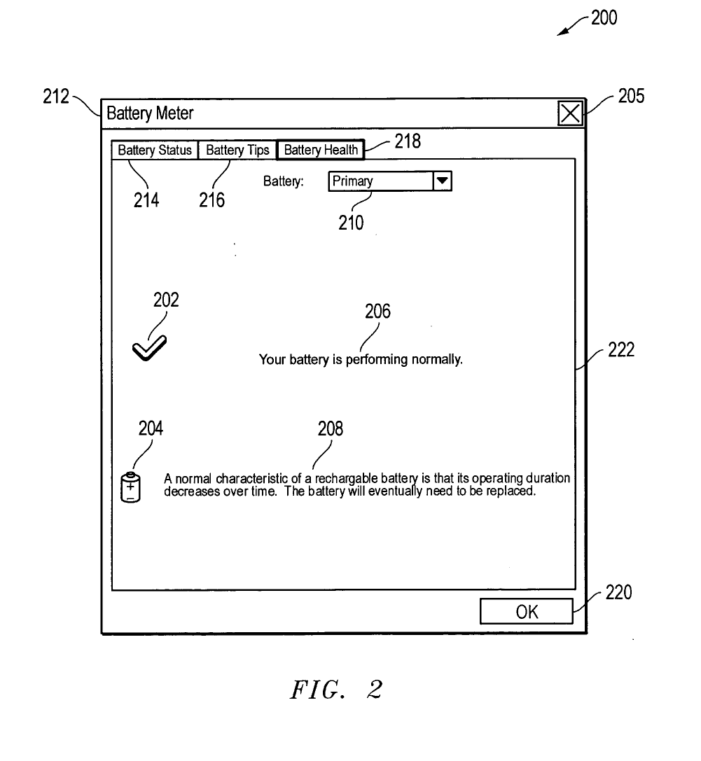

The present invention provides systems and methods for providing battery health information to users of portable information handling systems. FIG. 1 provides a block diagram for a portable information handling system utilizing a battery health monitor (BHM) according to the present invention, and FIGS. 2-5 provide example BHM information screens that may be displayed to a user. As recognized by the present invention and contrary to prior solutions, condition screens are provided throughout the batteries usable life and additional information is provided concerning what can be reasonably expected concerning the usable life of the rechargeable battery. As described below, this BHM solution of the present invention provides significant advantages to the management of user screen information and user expectations.

As discussed herein, there is a significant amount of confusion from customers regarding expectations of a batteries usable life. The first issue is that users do not necessarily understand that a rechargeable computer battery is a consumable item and that the performance will degrade over the battery's life cycle. The second issue is that users currently do not have an application to tell them whether the battery is performing normally. The battery health meter application of the present invention helps to educate users over time on battery usable life cycles and normal expected performance throughout that usable life cycle, as well as giving users a tool to check the current battery performance at any given time. The solution of the present invention provides this battery information in such a way that users can easily understand the battery end-of-life status and make decisions about whether they should purchase a replacement battery. Rather than providing information in terms of things like design capacity and cycle count, users are provided simple normal, cautionary, and critical icons with easy-to-understand messaging. The battery health monitor thereby provides customer experience enhancements (including proactive notification of need for new battery, easy online purchase process, and education on rechargeable battery behavior over time) and warranty benefits (including use as a technical support tool to assess remaining battery life). The battery health monitor of the present invention can operate within an appropriate tool running on the system. It is noted that in a DELL system, the battery health monitor can be housed within DELL QuickSet tool. The battery health window, or tab, within this tool can then contain different messaging, depending on the status of the battery, as discussed further below.

As also indicated below, different BHM condition information screens can be displayed to the user based upon battery end-of-life projections. In particular, percentages of battery usable life remaining can be used to set the levels at which the different conditions are deemed to exist. A number of different techniques and implementations can be used to determine such percentages. It is further noted that the condition levels can be user selectable through the BHM tool, if desired.

For example, these percentages can be determined by obtaining the number of recharge cycles that battery has been through and by comparing this actual number recharge cycles to the number of recharge cycles expected for that battery, according to the following equation:
ULRP=(Expected Cycles−Actual Cycles)/(Expected Cycles),
where ULRP represents the usable life remaining percentage, Expected Cycles represents the total number of expected recharge cycles for battery, and Actual Cycles represents the actual recharge cycles that have been used already. The total number of recharge cycles for any given battery can be information provided by the battery manufacturer and can be stored in appropriate look-up tables that can be accessed by the BHM tool.

In addition, percentage values for use by the BHM tool can be calculated using battery capacity parameters, if desired. While the number of cycles discussed above is an indirect measure of battery usable life, battery capacity can be used as a direct measure of battery usable life. In such an implementation, percentages can be utilized according to the following equation:
ULRP=(Full Charge Capacity−Current Charge Capacity)/(Full Charge Capacity),
where ULRP represents the usable life remaining percentage, Full Charge Capacity represents the full charge amount for battery when new, and Current Charge Capacity represents the current charge capacity for the batter. The full charge capacity for any given battery can be information provided by the battery manufacturer and can be stored in appropriate look-up tables that can be accessed by the BHM tool. It is noted that cycle measurements and charge measurements can be combined, if desired, to determine a percentage for the usable life remaining. In addition, as stated above, other parameters could be utilized as desired to determine a usable life remaining percentage.

It is further noted that with respect to the percentages of usable life remaining, the percentage values can be used but not displayed to the user. These percentage values can represent threshold trigger points that change the content and behavior of the BHM tool and the information screens. Because a battery begins to degrade exponentially and not linearly, exposing the percentage of remaining usable life to a user could be confusing. If desired, however, these percentages could nevertheless be displayed to the user. It is further noted that other parameters could be used, if desired, to trigger when each usable life condition level is reached and associated information screens could be displayed.

The following table provides one example for condition levels, thresholds used for determining when condition levels are reached, and the actions taken and information displayed for each example condition level.

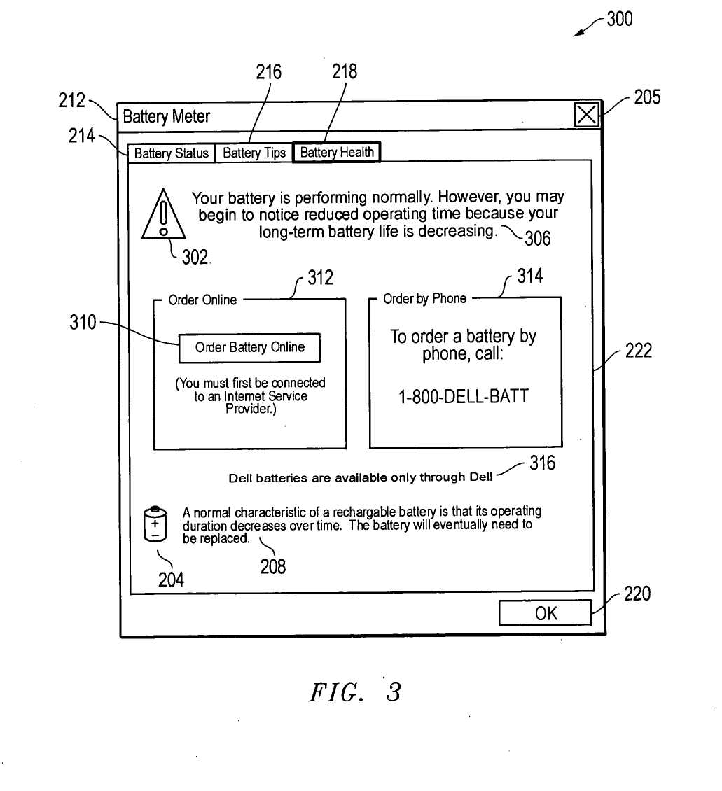

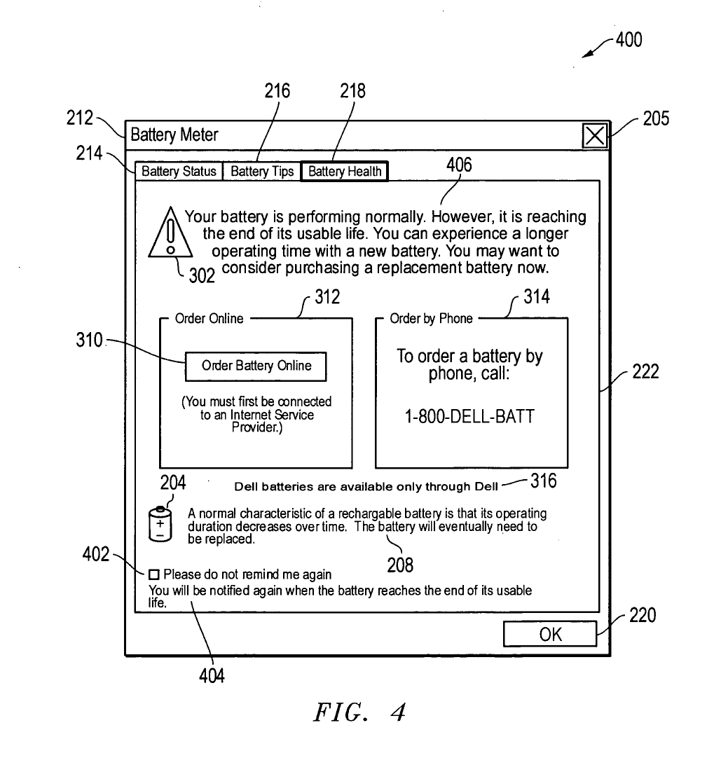

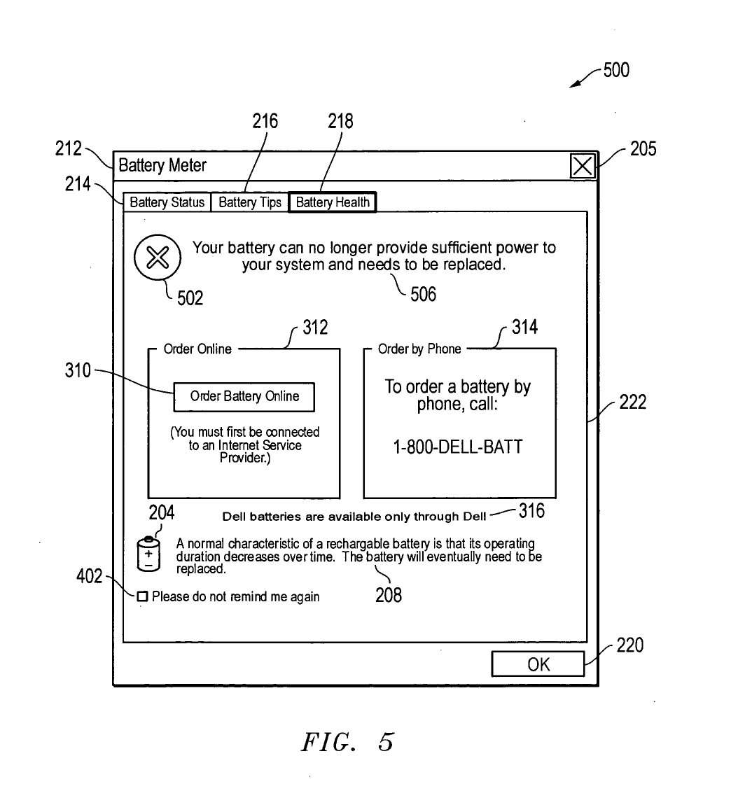

TABLE
EXAMPLE BHM INFORMATION SCREEN CONDITIONS
AND THRESHOLD TRANSITION LEVELS

| CONDITION | | |
|---|---|---|
| LEVEL | THRESHOLD | ACTION |
| GREEN OR | ≧65% remaining | If the battery is charging |
| NORMAL | battery usable | normally and has 65% or above |
| | life | of its remaining usable life, |
| | | the BHM window can contain a |
| | | good condition icon and |
| | | associated messaging. (See, |
| | | for example, screen 200 |
| | | in FIG. 2.) |
| CAUTION | <65% remaining | If the battery is charging |
| LEVEL 1 | battery usable | normally, but has less than |
| | life, but ≧50% | 65% of its life remaining, |
| | remaining battery | but greater than or equal |
| | usable life | to 50% of life remaining, |
| | | the BHM window can contain |
| | | a cautionary icon and |
| | | associated messaging. In |
| | | addition, information can |
| | | be provided regarding |
| | | ordering a replacement battery, |
| | | including a button that, if |
| | | clicked, will launch a battery- |
| | | specific site. (See, for |
| | | example, screen 300 in FIG. 3.) |
| CAUTION | <50% remaining | If the battery is charging |
| LEVEL 2 | battery usable | normally, but has less than |
| | life, but ≧25% | 50% of its life remaining, but |
| | remaining battery | greater than or equal to 25% |
| | usable life | of life remaining, the BHM |
| | | window can contain a second |
| | | cautionary icon and associated |
| | | messaging. The BHM window |
| | | messaging now changes to |
| | | emphasize the fact that the |
| | | battery is reaching the end |
| | | of its usable life. The |
| | | replacement battery ordering |
| | | options can still present |
| | | at this state. In addition, |
| | | BHM tool can launch a caution |
| | | pop-up the first time the |
| | | battery reaches this state. |
| | | Users can then have the |
| | | opportunity to choose not to |
| | | be reminded again via the |
| | | pop-up until the battery has |
| | | reached the end of its usable |
| | | life. (See, for example, |
| | | screen 400 in FIG. 4.) |
| CRITICAL | <25% remaining | When the battery reaches a |
| STATE | battery usable | state of having less than |
| | life | 25% of its remaining life or |
| | | has some other functional |
| | | failure, the user can be |
| | | notified with a pop-up that |
| | | informs them of the critical |
| | | condition of the battery |
| | | and the need for replacement. |
| | | The associated BHM window |
| | | can contain similar, stronger |
| | | icons and descriptive |
| | | messaging that tells the user |
| | | more specifically what is |
| | | wrong with the battery. This |
| | | window will also contain the |
| | | online ordering button. (See, |
| | | for example, screen 500 in |
| | | FIG. 5.) |

Looking now to FIG. 1, a block diagram is depicted for a portable information handling system (IHS) 150 with rechargeable batteries 102 and 104 and a battery health monitor (BHM) 100 displaying one of a plurality of BHM information screens 110 to a user of the portable information handling system. As depicted, the portable IHS 150 includes a primary battery 102 and a secondary battery 104 that are both rechargeable. The two rechargeable batteries 102 and 104 are coupled to a power supply controller 106 through which power is controlled and supplied to the circuitry and devices within the portable IHS 150. According to the present invention, the portable IHS 150 also includes a battery health monitor 100 coupled to the primary battery 102 and the secondary battery 104 to receive information from these batteries concerning their operation. Based upon this information, for each battery, the batter health monitor 100 can display one of a plurality of BHM information screens 110 that will inform the user of the relative operational health of the battery in addition to providing the user information concerning the reasonable expected usable life and performance of the rechargeable battery.

In addition, customer usage data 108 can be stored by the battery health monitor and can be transferred across a network connection for the IHS 150, if desired. This customer usage data 108 can include information such as battery usage profiles, battery health data, and other battery related data. This customer usage data 108 can be utilized for troubleshooting by the user or a remote technician, for real-life customer usage models when aggregated with customer usage data from other users, and/or for any other desired data analysis purposes.

In the embodiment depicted, BHM information screens 110 have been selected to be four different screen displays depending upon operational performance parameters determined for the relevant battery. Screen display 200 is labeled GREEN and represents an operational level at which the battery is performing in a good or normal range. Screen display 500 is labeled CRITICAL and represents an operational level at which the battery is performing in inadequate manner and should be replaced. Screen display 300 is labeled CAUTION LEVEL 1 and represents an operational level at which the battery is performing satisfactorily but is below the good/normal range. Finally, screen display 400 is labeled CAUTION LEVEL 2 and represents an operational level at which the battery is performing satisfactorily but is just above the CRITICAL level 500. FIGS. 2-5 provide example embodiments for screen displays 200, 300, 400 and 500, respectively. It is noted that these screen displays include information that would be relevant for DELL systems, such as battery ordering phone numbers. It is further noted that example threshold levels for determining when each of these conditions are reached is provided with respect to the TABLE presented above.

It is noted that the two battery example of FIG. 1 is simply one example embodiment. An IHS 150 could also have a single battery, if desired, and could also have more than two batteries, if desired. As discussed herein, the battery health monitor 100 can provide a user visibility into the relative health of each battery installed within the IHS 150. In addition, information for the batteries can be combined into a single display screen or can be separated into different display screens, as desired. In addition, any number of performance levels and related BHM information screens 110 can be utilized as long as there is at least one screen display that represents a battery performing in a good or normal range. In the embodiment of FIG. 1, this is the GREEN screen display 200.

FIG. 2 is a diagram for a good or normal condition BHM information screen 200 that may be displayed to a user according to the present invention. This good condition screen 200 can be made to appear like a standard window 212 in a MICROSOFT WINDOWS operating system environment. For example, there is an “X” box 205 at the top right providing a close window function and an “OK” button at the bottom right to accept settings and close the window. As depicted, the window 212 is labeled “Battery Meter” and includes tab 214 labeled “Battery Status,” tab 216 labeled “Battery Tips,” and tab 218 labeled “Battery Health.” In addition, as depicted, the “Battery Health” tab 218 has been selected by a user and information related to that tab is being provided to the user within box 222. The “Battery Status” tab 214 is intended for use in displaying typical charge-remaining information to a user. The “Battery Tips” tab 216 is intended for use in displaying battery help information.

With respect to “Battery Health” tab 128 which has been selected, a drop down box 210 is provided for selection of the battery for which information will be displayed. In FIG. 2, the “Primary” battery has been selected in this drop down box 210. It is noted that this drop down box 210 is not depicted in FIGS. 2-4, but could be included in those screens, if desired. Box 222 also includes the BHM information provided to the user. The green check mark 202 is a graphical representation of the good or normal condition. The phrase 206 provides a text statement indicating the good condition, such as “Your battery is performing normally.” A subject matter symbol 204 can also be displayed and can be, for example, a graphical representation of a battery. The phrase 208 provides a text statement indicating realistic expectations concerning rechargeable batteries and their limited usable life expectancy, such as “A normal characteristic of a rechargeable battery is that its operating duration decreases over time. The battery will eventually need to be replaced.” It is noted that some of the information within box 222 can be specific to the current condition level of the battery, such as elements 202 and 206, and some of this information can always be displayed, such as elements 204 and 208.

FIG. 3 is a diagram for a first level caution condition BHM information screen 300 that may be displayed to a user according to the present invention. As seen in a comparison between FIG. 2 and FIG. 3, instead of the GREEN condition information elements 202 and 206, the user now sees CAUTION LEVEL 1 information. In particular, a caution symbol 302 can be displayed and can be, for example, a triangle with an exclamation point. The phrase 306 provides a text statement indicating the caution condition, such as “Your battery is charging normally. However, you may begin to notice reduced operating time because your long-term battery life is decreasing.” Along with this caution condition information, ordering information can also be provided so that a user can easily obtain a replacement battery, if desired. For example, box 312 can be provided for ordering online, and box 314 can be provided for ordering by phone. Box 312 is labeled “Order Online,” includes an Order Battery Online button 310, and includes a connectivity statement saying “(You must first be connected to an Internet Service Provider.)” By selecting the button 310, a user is taken to a website through a browser loaded on the system where the user could purchase a replacement battery. For example, the user can be directed to a specific website depending upon the user's specific computer (for example, with respect to a Dell computer system, the website information can depend upon on the Express Service Code for the system), and the website can provide specific information about the batteries for that system (for example, whether the battery is still under warranty, subject to special warranty terms, etc.) Box 314 is labeled “Order by Phone” and includes relevant phone information, such as “To order a battery by phone, call: 1-800-DELL-BATT.” Phrase 316 can also be provided to include additional information, such as “Dell batteries are available only through Dell.” As indicated above, elements 204 and 206 remain the same as in FIG. 2.

FIG. 4 is a diagram for a second level caution condition BHM information screen 400 that may be displayed to a user according to the present invention. As seen in comparison between FIG. 3 and FIG. 4, instead of CAUTION LEVEL 1 information 306, the user now sees CAUTION LEVEL 2 information. In particular, phrase 408 states “Your battery is charging normally; however, it is reaching the end of its usable life. You can experience a longer operating time with a new battery. You may want to consider purchasing a replacement battery now.” Elements 302, 310, 312, 314 and 316 have remained the same.

In the embodiment of FIG. 4, it is also contemplated that the screen 400 will be automatically displayed to a user when the CAUTION LEVEL 2 performance level is reached. Thus, unlike screens 200 and 300 of FIGS. 2-3, which are intended to be viewed through user control and access through the BHM tool, screen 400 is designed to be displayed periodically as a pop-up window until a new battery is installed. Check box 402 has also been added along with the phrase “Please do not remind me again” and the additional phrase 404 which states “You will be notified again when the battery reaches the end of its usable life.” This check box 402 provides the user the ability to stop additional notices until the battery reaches the CRITICAL condition level. It is also noted that the battery meter window 212 and/or battery health tab 218 could also have a control interface allowing a user to select what types of notices the user will receive and the timing of those notices.

FIG. 5 is a diagram for a critical condition BHM information screen 500 that may be displayed to a user according to the present invention. As seen in comparison between FIG. 4 and FIG. 5, instead of CAUTION LEVEL 2 information 406 and graphic 302, the user now sees CRITICAL condition information. In particular, phrase 506 states “Your battery can no longer provide sufficient power to your system and needs to be replaced.” A critical symbol 502 can also now be displayed, such as a circle with an “X” within it. As with screen 400, screen 500 is designed to be displayed periodically as a pop-up window until a new battery is installed. Elements 302, 310, 312, 314 and 316 have remained the same, as well as the check box 402 and the phrase “Please do not remind me again.” This check box provides the user the ability to stop additional notices that the battery has reached a CRITICAL performance level.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method for informing a user of battery usable life information for an information handling system, comprising:
determining a current usable life condition for at least one rechargeable battery within an information handling system;
displaying normal level condition information to a user when the usable life condition is above a normal threshold level, the normal level condition information including usable life expectation information;
displaying critical level condition information to a user when the usable life condition below is a critical threshold level; and
displaying caution level condition information to a user when the usable life condition is below the normal threshold level and above the critical threshold level.

2. The method of claim 1, wherein the usable life expectation information comprises information informing the user that the rechargeable battery has a limited usable life and at some point will have to be replaced.

3. The method of claim 2, wherein the usable life expectation information is also displayed along with the critical level condition information and the caution level condition information.

4. The method of claim 1, wherein the displaying normal level condition information step comprises displaying a normal condition symbol and a normal condition message; wherein the displaying critical level condition information step comprises displaying a critical condition symbol and a critical condition message; and wherein the displaying caution level condition information step comprises displaying a critical condition symbol and a critical condition message.

5. The method of claim 1, further comprising storing battery usage data related to the battery.

6. The method of claim 6, further comprising allowing a user to select one of a plurality of rechargeable batteries for which battery usable life information will be displayed.

7. The method of claim 1, further comprising displaying battery ordering information along with the caution level condition information or the critical level condition information, or both.

8. The method of claim 7, wherein the battery ordering information includes a link to a battery ordering website.

9. The method of claim 1, wherein the displaying caution level condition information step comprises displaying first caution level condition information when the usable life condition is below the normal threshold level and above a caution threshold level and displaying second caution level condition information when the usable life condition is below the caution threshold level and above the critical threshold level.

10. The method of claim 1, wherein the determining step comprises obtaining information from the battery and determining a percentage of usable life remaining as a representation for the current usable life condition for the rechargeable battery.

11. The method of claim 12, further comprising allowing a user to select the percentages used for the threshold levels.

12. The method of claim 10, further comprising determining a percentage of usable life remaining by obtaining a number of actual recharge cycles used for the battery and comparing it to an expected number of total recharge cycles for the battery, or by obtaining a current charge capacity for the battery and comparing it to a full charge capacity for the battery, or by doing both.

13. The method of claim 1, further comprising automatically displaying the caution condition level information to the user when the caution threshold condition level is reached and automatically displaying the critical condition level information to the user when the critical condition threshold level is reached.

14. A battery health monitor for informing a user of battery usable life information for a rechargeable battery within an information handling system, comprising:
normal level condition screen information configured to be displayed to a user when a current usable life condition for a rechargeable battery is above a normal threshold level, the normal level condition screen information including usable life expectation information;
critical level condition screen information configured to be displayed to a user when the current usable life condition below is a critical threshold level; and
caution level condition screen information configured to be displayed to a user when the current usable life condition is below the normal threshold level and above the critical threshold level.

15. The battery health monitor of claim 14, wherein the usable life expectation information comprises information informing the user that the rechargeable battery has a limited usable life and at some point will have to be replaced.

16. The battery health monitor of claim 14, wherein the usable life expectation information is also displayed along with the critical level condition information and the caution level condition information.

17. The battery health monitor of claim 14, wherein the caution level condition screen information comprises first caution level condition screen information configured to be displayed when the usable life condition is below the normal threshold level and above a caution threshold level and second caution level condition screen information configured to be displayed when the usable life condition is below the caution threshold level and above the critical threshold level.

18. The battery health monitor of claim 14, wherein the current usable life condition for the rechargeable battery is based upon a percentage of usable life remaining for the rechargeable battery.

19. The battery health monitor of claim 14, wherein the percentage of usable life remaining is dependent upon a comparison of a number of actual recharge cycles used and an expected number of total recharge cycles for the battery, or upon a comparison of current charge capacity and a full charge capacity for the battery, or upon both.

20. The battery health monitor of claim 14, further comprising a selectable menu configured to allow a user to select one of a plurality of rechargeable batteries for which battery usable life information will be displayed.
